(19) United States
(12) Patent Application Publication
(10) Pub. No.: US 2013/0192184 A1
(43) Pub. Date: Aug. 1, 2013

(54) LAWN MOWER ROBOT AND METHOD OF CONTROLLING THE SAME

(71) Applicants: Kyuchun Choi, Seoul (KR); Hyunsup Song, Seoul (KR); Chungook Chong, Seoul (KR)

(72) Inventors: Kyuchun Choi, Seoul (KR); Hyunsup Song, Seoul (KR); Chungook Chong, Seoul (KR)

(73) Assignee: LG ELECTRONICS INC., Seoul (KR)

(21) Appl. No.: 13/565,253

(22) Filed: Aug. 2, 2012

(30) Foreign Application Priority Data
Aug. 3, 2011 (KR) 10-2011-0077454

(51) Int. Cl. A01D 34/00

(52) U.S. Cl. CPC A01D 34/008; Y10S 901/01
USPC 56/10.2 A; 701/50; 901/1

(57) ABSTRACT

The present embodiment relates to a lawn mower robot. A lawn mower robot includes a body having a moving device; a mowing device disposed in the body and mowing lawns; a sensor disposed in the body and receiving light signal from the outside; and a controller controlling the moving device and mowing device, wherein, when the sensor senses the light signal, the controller allows the mowing device to be operated, and when the sensor does not sense the light signal, the controller allows the mowing device to be stopped.

### CROSS-REFERENCE TO RELATED APPLICATIONS

The present application claims priority under 35 U.S.C. 119 and 35 U.S.C. 365 to Korean Patent Application No. 10-2011-0077454 (filed on Aug. 3, 2011), which is hereby incorporated by reference in its entirety.

### BACKGROUND

The present disclosure relates to a lawn mower robot and a method of controlling the same.

A lawn mower is an apparatus for mowing lawns planted in a home's yard or playground and the like. Such a lawn mower may be classified into a type used at home, and a tractor type used in a wide playground or farm.

The lawn mower for home is classified into a walk behind type for mowing the lawn while directly dragging the lawn mower from behind, and a directly hand carrying type.

However, there are burdens in that humans should directly operate all of two types of the lawn mower. Particularly, since it is difficult to mow the lawn of a playground by directly operating the lawn mower by an user in today's busy daily life, it is generous to hire outside humans so as to mow the lawns, thereby to generate hiring cost.

### SUMMARY

Embodiments provide a lawn mower robot, and a method of controlling the same.

In one embodiment, a lawn mower robot system comprises: a boundary display apparatus having a signal producing unit for producing light signal; and a lawn mower robot including a moving device, a mowing device for mowing lawns, a sensor for sensing the light signal, and a controller controlling the mowing device, wherein the controller controls the mowing device, depending on whether the sensor senses the light signal.

In another embodiment, a lawn mower robot comprises: a body having a moving device; a mowing device disposed on the body and mowing lawns; a sensor disposed on the body and receiving light signal from the outside; and a controller that controls the moving device and mowing device, wherein, when the sensor senses the light signal, the controller allows the mowing device to be operated, and when the sensor does not sense the light signal, the controller allows the mowing device to be stopped.

In further another embodiment, a method of controlling a lawn mower robot comprises: turning on a sensor for sensing light signal; determining whether the sensor senses light signal; and controlling turn on/off of a mowing device for mowing lawns, depending on whether the sensor senses the light signal.

The details of one or more embodiments are set forth in the accompanying drawings and the description below. Other features will be apparent from the description and drawings, and from the claims.

### BRIEF DESCRIPTION OF THE DRAWINGS

FIG. 1 is a plan view for a lawn mower robot according to the present embodiment.

FIG. 2 is a perspective view for boundary display apparatuses according to the present embodiment.

FIG. 3 is a block view for a lawn mower robot system according to the present embodiment.

FIG. 4 is a view for the lawn mower robot system 1 and a lawn presence area G according to the present embodiment.

FIG. 5 is a flow chart for describing a method of controlling the lawn mower robot system 1 according to the present embodiment.

### DETAILED DESCRIPTION OF THE EMBODIMENTS

Reference will now be made in detail to the embodiments of the present disclosure, examples of which are illustrated in the accompanying drawings.

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense.

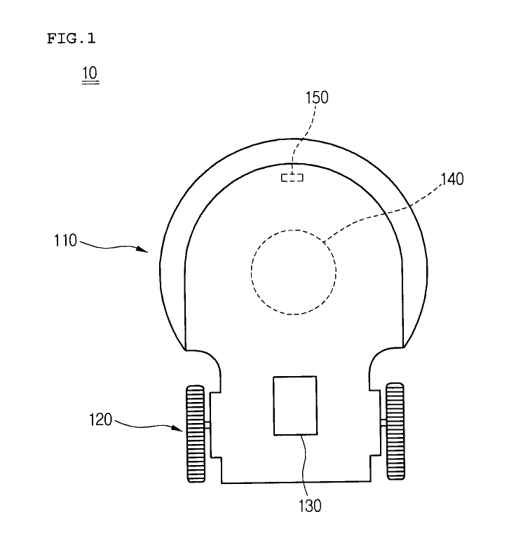

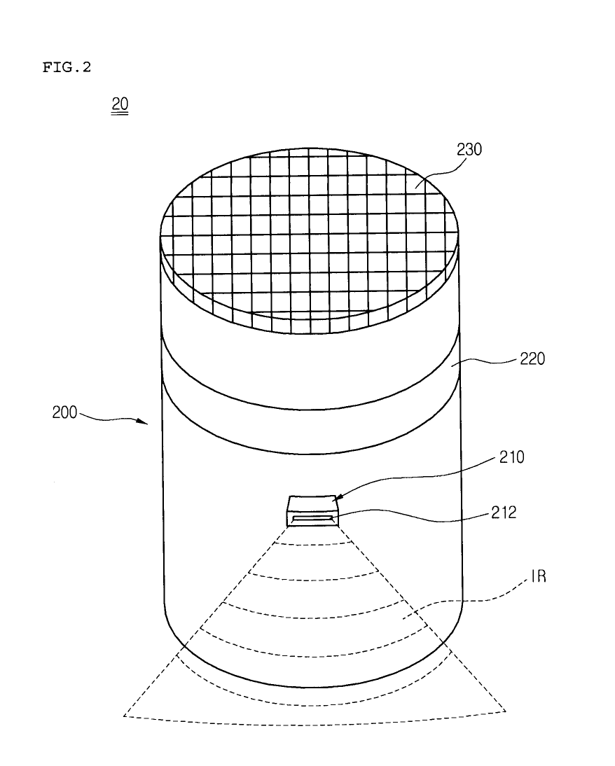

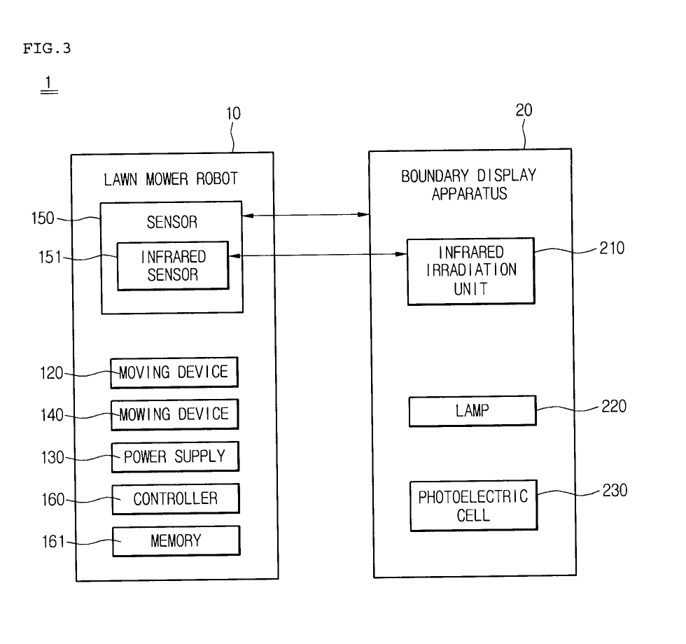

FIG. 1 is a plan view for a lawn mower robot according to the present embodiment, FIG. 2 is a perspective view for boundary display apparatuses according to the present embodiment, and FIG. 3 is a block view for the lawn mower robot system according to the present embodiment.

Referring to FIGS. 1 to 3, the lawn mower robot 10 according to the present embodiment includes a body 110 having a moving device 120 and forming an appearance, a mowing device 140 disposed in a bottom of the body 110 and mowing lawns, a sensor 150 disposed in the body 110 and sensing outside information, a power supply 130 supplying power to the lawn mower robot 10, and a controller 160 disposed in the body 110 and controlling various electronic parts.

The body 110 forms the appearance of the lawn mower robot 10, and various electrical/mechanical parts are received in the inside thereof. The body 110 may be disposed with the power supply 130 for supplying power to the lawn mower robot 10.

The power supply 130 may be a chargeable and dischargeable battery (second cell). The power supply 130 may be charged by outside power. The power supply 130 may be implemented by a replaceable primary cell, and is connected to the outside through lines to receive commercial power supply. Hereinafter, although it is described that the power supply 130 is implemented by the second cell, it is not limited thereto.

The power supply 130 is separately coupled with the body 110, or may be detachably connected to a charging device (not shown) to be supplied with outside current. In this case, the charging device is connected to the outside power to supply current, the charging device is interactively communicated with the lawn mower robot 10 such that the lawn mower robot 10 returns to the charging device for oneself to charge the power supply 130 by the charging device.

The moving device 120 may move the lawn mower robot 10. The moving device 120 may include a plurality of wheels, and a plurality of motors for separately driving the plurality of wheels. Rotation velocities of the wheels between the plurality of wheels become different by separately controlling the plurality of motors such that direction switching is possible. Each of the plurality of motors is bidirectional rotating motors. Therefore, the lawn mower robot 10 may move forwarded or backward, or left or right.

The sensor 150 may sense objects in the vicinity of the lawn mower robot 10, and sense humans, animals, stationary objects or moving objects and the like.

The sensor 150 may also sense outside temperature or humidity, sunshine intensity, air volume and the like.

The sensor 150 may sense presence or absence of the lawns. The sensor 150 may be implemented by the sensor for sensing at least one of color, perfume and spectrum of the lawns.

The sensor 150 may include at least one of a mechanical sensor, an optical sensor, a chromatic sensor, a radio frequency sensor, a capacitive sensor, an ultrasonic sensor, an infrared ray sensor, a RGB sensor, a spectrum sensor and the like according to the embodiment.

Hereinafter, for example, it is described that the sensor 150 includes the infrared ray sensor 151 for sensing an infrared ray, and the ultrasonic sensor 153 for sensing presence or absence of the boundary display apparatuses 20, but it is limited thereto.

The mowing device 140 is disposed in the body 110, and therefore, mows the lawns. The mowing device 140 is disposed in the bottom of the body 110, thereby to dispose toward the region having the lawn (hereinafter, refer to ‘a lawn presence region G’). When the mowing device 140 is driven by a controller 160, the lawns in the lawn presence region G are mowed.

The mowing device 140 may be implemented by a blade type, a circle blade type, a reel type, a line or strand type formed with a cutter with rope, and other well-known cutter and the like.

The body 110 is disposed with the controller 160. The controller 160 controls all the electronic/mechanical devices disposed in the lawn mower robot 10. The controller 160 controls the above-described moving device 120 and the mowing device 140, receives data sensed from the sensor 150 and the like, then, may store it into a memory 161, and may control the electronic/mechanical devices disposed in the lawn mower robot 10 based on the stored data.

Referring to FIGS. 2 and 3, the boundary display apparatuses 20 according to the present embodiment include a housing 200 forming the appearance, a photovoltaic cell 230 disposed in the housing 200 and producing the current by receiving light, and an infrared ray irradiation unit 210 disposed in the housing 200 and irradiating the infrared ray using the current produced from the photovoltaic cell 230.

The infrared ray irradiation unit 210 may be called a signal production unit. Of course, the signal production unit of the present embodiment may produce various light signals except the infrared ray, and the sensor may sense various light signals.

The housing 200 forms the appearance of the boundary display apparatuses 20. The housing 200 may function as an ornament for a graceful landscape according to the embodiment, and may be formed in various shapes.

In FIG. 2, for an example, it is showed that the housing 200 is formed in a cylindrical shape, but it is not limited thereto.

The photoelectric cell 230 receives the light to produce the current. The photoelectric cell 230 may be disposed in the side or top of the housing 200. The photoelectric cell 230 may be implemented by a sunlight cell 230 for producing the current by receiving sunlight, but the kind of the photoelectric cell 230 is not limited. The current produced from the photoelectric cell 230 may be stored in a power storage unit (not shown) disposed in the housing 200.

The infrared ray irradiation unit 210 is disposed to allow the infrared ray to be irradiated to the outside of the housing 200, and the housing 200 may be disposed with a plurality of the infrared ray irradiation unit 210. Hereinafter, for example, it is described that two infrared irradiation units 210 are spaced apart from each other by a predetermined angle in the housing 200, but the number of the infrared irradiation unit is not limited.

The infrared irradiation unit 210 irradiates the infrared ray to the outside of the housing 200 using the current produced from the photoelectric cell 230. The infrared ray to be irradiated is irradiated in a straight line or may be irradiated in a predetermined angle and limit from the infrared irradiation unit 210. Hereinafter, it is described that the infrared irradiation unit 210 irradiates the infrared ray in a straight line, but the infrared ray may be irradiated on the two dimensional plan or three dimensional space in a predetermined range and angle.

The infrared irradiation unit 210 includes a guide section 212 for setting the limit which irradiates the infrared ray IR. The guide section 212 may limit an irradiation angle of the infrared ray IR so that the infrared ray irradiated from the infrared irradiation unit 210 is irradiated only in a certain limit.

The boundary display apparatuses 20 may be disposed with a lamp 220 emitting the light. The lamp 220 is turned off by day, and may be operated at night. The lamp 220 may be operated using the current produced from the photoelectric cell 230.

As the boundary display apparatuses 20 produce the current using the photoelectric cell 230, the lawn presence area G to be described later may be displayed by irradiating the infrared ray from the infrared irradiation unit 210 by day, and the operated lamp 220 may be used as a lighting that allows the landscape of the lawn presence area G to be graceful at night.

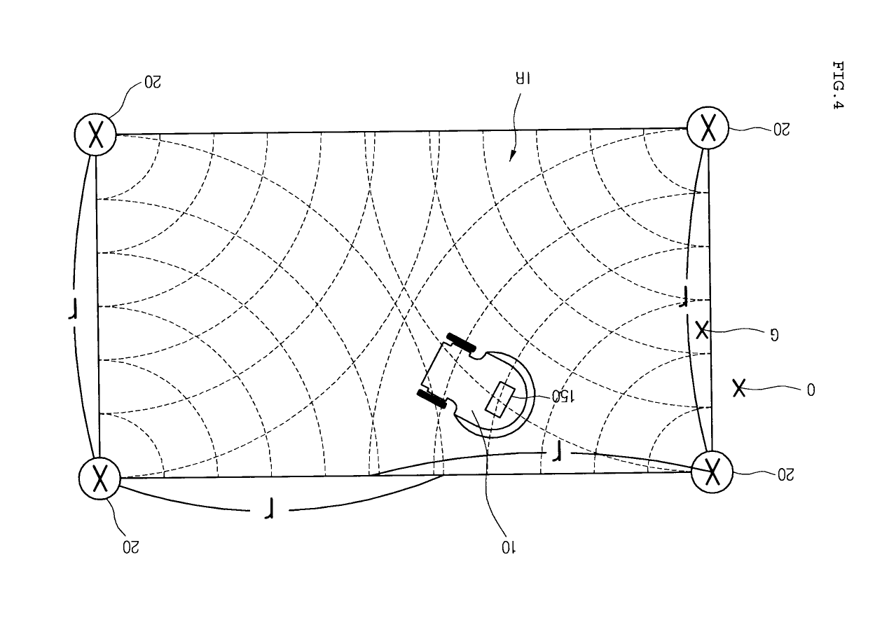

FIG. 4 is a view for the lawn mower robot system 1 and a lawn presence area G according to the present embodiment.

Referring to FIG. 4, the lawn presence area G is defined as the region having the lawn. The region having the lawn is generally partitioned into the region having lawn in a certain area to distinguish from different area at home or in a industrial environment. In this case, a boundary area B separates the lawn presence region G having the lawn and the other remaining area O (outside region). The boundary area B may form an enclosed path.

Some lawns may be present even on the other remaining region O having not the lawns, but, hereinafter, it is described that a lot of lawns are present in the lawn presence region G based on the boundary area B and the other remaining region O includes soil, concrete, block, road and the like having little lawn or plants.

At least one boundary display apparatuses 20 may be disposed in the lawn presence region G according to the limit of the lawn presence region G.

In FIG. 4, for an example, the lawn presence region G is defined as a rectangle by four boundary display apparatuses 20, but it is not limited thereto.

The boundary display apparatuses 20 display the boundary area B of the lawn presence region G by the infrared ray irradiated from the infrared irradiation unit 210. The boundary display apparatuses 20 form apexes of each of the rectangle, the infrared ray irradiated from each of the infrared ray irradiation unit 210 forms segments of the rectangle, and the rectangle including the segments and the apex forms the boundary area B. At this time, the region in the inside of the boundary area B becomes the lawn presence region G.

When the sensor 150 is spaced in a certain distance apart from the infrared ray irradiation unit 210, it may sense the infrared ray IR irradiated from the infrared ray irradiation unit 210. In an embodiment shown in FIG. 4, when the sensor 150 positions within the distance from the infrared ray irradiation unit 210 to a radius r, it may sense the infrared ray.

The infrared ray irradiation unit 210 may limit the irradiation angle of the infrared ray IR so that the infrared ray is irradiated only in the limit forming a certain angle. In the case of the rectangle shown in FIG. 4, as each of the boundary display apparatuses 20 are disposed in each of the corners, each of the infrared ray irradiation unit 210 may irradiate the infrared ray within an irradiation limit having about 90 degrees.

Some infrared ray IR irradiated from each of the infrared ray irradiation unit 210 may be overlapped from each other. The infrared ray IR irradiated by an irradiation distance from the infrared ray irradiation unit 210 to the radius r is irradiated by ¼ circle (a quadrant) from each of the infrared ray irradiation unit 210. In this case, when some infrared rays IR are not overlapped with each other in a center of the lawn presence region G, the limit not irradiated with the infrared ray may be caused. To prevent this, some infrared rays IR irradiated from the infrared ray irradiation unit 210 are overlapped with each other in the center of the lawn presence region G such that the center of the lawn presence region G may be included in the limit irradiated with the infrared ray.

The sensor 150 may include the infrared ray sensor 151, and the infrared ray sensor 151 may sense the infrared ray irradiated from the infrared irradiation unit 210. The sensor 150 senses the infrared ray while moving in the lawn presence region G and transmits the sensed result to the controller 160.

The sensor 150 senses only the infrared ray having a certain output among the infrared ray IR irradiated from the infrared ray irradiation unit 210, and ignores the sensed result for other infrared rays IR having low output or does not sense them. The limit that may ignore the sensed result for other infrared rays IR may be stored into the memory of the controller 160 as initial setting values.

The infrared ray irradiation unit 210 regularly maintains the output of the infrared ray IR irradiated to the lawn presence region G to not irradiate the infrared ray IR outside the lawn presence region G or allows the infrared ray IR sensed outside the lawn presence region G to be irradiated as the output ignored from the sensor 150.

The controller 160 controls the moving device 120 and/or the mowing device 140 according to the result sensed by the sensor 150. On moving the lawn mower robot 10 by the moving device 120, the controller 160 determines whether the infrared ray IR is sensed by the sensor 150. When the sensor 150 does not sense the infrared ray IR, the controller 160 determines that the lawn mower robot is deviated from the lawn presence region G, thereby to stop or turn off the mowing device 140.

When the controller 160 determines that the lawn mower robot 10 is deviated from the lawn presence region G, it may control the moving device 120 to move the lawn mower robot 10 inside the lawn presence region G sensed with the infrared ray IR by the sensor 150.

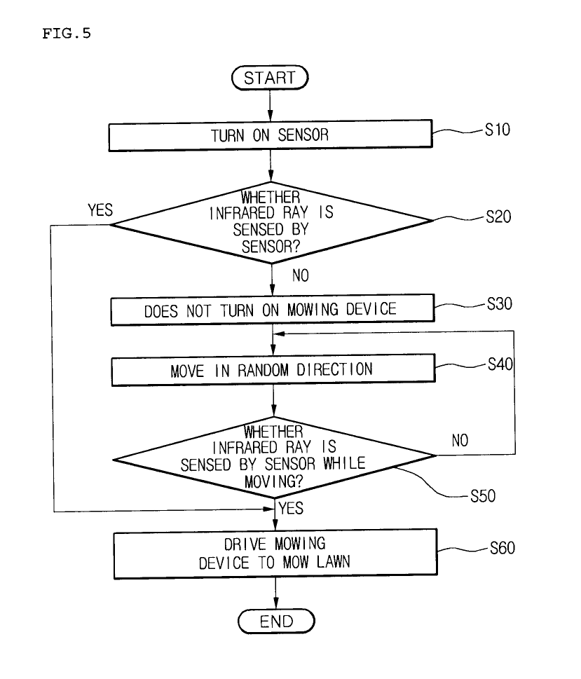

FIG. 5 is a flow chart for describing a method of controlling the lawn mower robot system 1 according to the present embodiment.

Referring to FIGS. 4 to 5, the method of controlling the lawn mower robot system 1 is described.

First, the lawn mower robot 10 is turned on. When the lawn mower robot 10 is turned on, the sensor 150 is turned on (S10). The sensor 150 is initially turned on in the lawn presence region G, or the lawn mower robot may be turned on outside the lawn presence region G.

When the sensor 150 is turned on, the mowing device 140 may be also turned on. When the lawn mower robot 10 is arranged in the lawn presence region G by the user and is turned on, the sensor 150 and the mowing device 140 may be turned on.

The controller 160 determines whether the infrared ray is sensed by the sensor 150 (S20). When the infrared ray is sensed by the sensor 150, the controller 160 determines that a current position of the lawn mower robot 10 is positioned in the lawn presence region G and allows the mowing device 140 to turn on. When the mowing device 140 is driven, the mowing device 140 mows the lawns in the lawn presence region G (S60).

When the sensor 150 does not sense the infrared ray or the result which senses the infrared ray becomes an ignorable level, the controller 160 determines that the current position of the lawn mower robot 10 is positioned outside the lawn presence region G and allows the mowing device 140 not to turn on (S30). Further, when the sensor 150 does not sense the infrared ray, the moving device 120 may be stopped. Further, after the time that does not sense the infrared ray by the sensor 150 lapses a certain time, the moving device 120 may be stopped.

In the embodiment not driven with the mowing device 140, after turning on the mowing device 140, when the current position of the lawn mower robot 10 is positioned outside the lawn presence region G, the controller 160 stops the mowing device 140.

The controller 160 drives the mowing device 120 to move the lawn mower robot 10 in a random direction (S40). The controller 160 determines whether the infrared ray is sensed by the sensor 150 (S50) on moving in the random direction. When the sensor 150 does not sense the infrared ray or the result which senses the infrared ray becomes the ignorable level, the controller 160 continually drives the moving device 120 to move the lawn mower robot 10 again in the random direction (S40).

When the sensor 150 senses the infrared ray, the controller 160 drives the mowing device 140 to mow the lawn (S60). The one that drives the mowing device 140 by the controller 160 includes the one that turns off the mowing device 140 and then turns on it, and the one that stops the turned on mowing device 140 and then turns on it again.

According to an embodiment of the present invention, as the lawn mower robot senses the lawn presence region displayed by the boundary display apparatuses, the lawn mower robot may mow the lawn in the lawn presence region for oneself, thereby to solve the burden of a user.

Further, when the infrared ray is not sensed by the sensor, the controller stops the mowing device not to drive the mowing device outside the lawn presence region such that it is possible to prevent the user or animal from hurting.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A lawn mower robot system, comprising:
a boundary display apparatus having a signal producing unit to produce light signal; and
a lawn mower robot including a moving device, a mowing device for mowing lawns, a sensor for sensing the light signal, and a controller controlling the mowing device,
wherein the controller controls the mowing device, depending on whether the sensor senses the light signal.

2. The lawn mower robot system according to claim 1,
wherein, when the sensor senses the light signal, the controller allows the mowing device to be turned on.

3. The lawn mower robot system according to claim 2, wherein, when the sensor does not sense the light signal, the controller allows the mowing device to be turned off.

4. The lawn mower robot system according to claim 1, wherein the light signal is an infrared ray, and the sensor includes an infrared ray sensor for sensing the infrared ray.

5. The lawn mower robot system according to claim 4, wherein the signal producing unit includes a guide section for setting an irradiating limit for the infrared ray.

6. A lawn mower robot, comprising:
a body including a moving device;
a mowing device disposed on the body and mowing lawns;
a sensor disposed on the body and receiving light signal from the outside; and
a controller that controls the moving device and mowing device,
wherein, when the sensor senses the light signal, the controller allows the mowing device to be turned on, and when the sensor does not sense the light signal, the controller allows the mowing device to be turned off.

7. The lawn mower robot according to claim 6, wherein when the mowing device is turned off and the sensor senses the light signal, the controller allows the mowing device to be turned on.

8. The lawn mower robot according to claim 6, wherein when the mowing device is turned on and the sensor does not sense the light signal, the controller allows the mowing device to be turned off.

9. The lawn mower robot according to claim 6, wherein, when the sensor does not sense the light signal, the controller allows the moving device to be turned off.

10. A method of controlling a lawn mower robot, comprising:
turning on a sensor for sensing light signal;
determining whether the sensor senses light signal and;
controlling turn on/off of a mowing device for mowing lawns, depending on whether the sensor senses the light signal.

11. The method according to claim 10, wherein, when the sensor senses the light signal, the mowing device is turned on, and when the sensor does not sense the light signal, the mowing device is turned off.

12. The method according to claim 10, further comprising turning on the moving device for moving,
wherein, after turning on the moving device, when the sensor does not sense the light signal, the mowing device is turned off.

13. The method according to claim 10, wherein the light signal is an infrared ray.
